(19) United States
(12) Patent Application Publication
(10) Pub. No.: US 2011/0083085 A1
(43) Pub. Date: Apr. 7, 2011

(54) Rules-Based Fan Interaction Engine, System and Method

(76) Inventors: Ryan Steelberg, Irvine, CA (US); Chad Steelberg, Newport Beach, CA (US)

(21) Appl. No.: 12/872,392

(22) Filed: Aug. 31, 2010

Related U.S. Application Data
(60) Provisional application No. 61/278,222, filed on Oct. 2, 2009.

(51) Int. Cl. G06F 3/01; G06F 15/16

(52) U.S. Cl. 715/753

(57) ABSTRACT

A rules-based fan interaction engine, system and method. The engine, system and method include a fan interaction software mechanism for execution by one or more computing processors, including at least one data source associated with at least one relational computing database including a plurality of data indicative of at least two media talents, at least one network communication engine that allows for interactive, real time communications between one or more mobile communication units, and at least one administrative engine for administrating the interactive, real time communications between the at least two users.

### CROSS-REFERENCE TO RELATED APPLICATIONS

This application is a continuation-in-part of U.S. Patent Application Ser. No. 61/278,222, entitled “A Rules Based Fan Interaction Engine, System and Method”, filed Oct. 2, 2009, which application is hereby incorporated by reference herein as if set forth in their entirety

### FIELD OF THE INVENTION

The present invention is directed to fan interactions and, more particularly, to a rules-based fan interaction engine, system and method.

### BACKGROUND OF THE INVENTION

Sports fans love their favorite teams and their favorite players. Often any rivalry that is present on the playing field is amplified within the respective fan bases of the rival teams. For example, Oakland Raiders' fans are well known, if not infamous, for their exploits in supporting their team, and Chicago Cubs' fans are often admired for an unwavering commitment to their team in its seemingly unending quest for a first championship in over 100 years.

An aspect of rooting for a team is often a good-natured, or a not particularly good-natured, verbal dispute between rival fan bases. The good and bad qualities of teams and their players have been debated by fans of those teams and players since the inception of sport. Such verbal sparring often includes a “put down” directed toward an opposing team, its players, and/or its fans. More often than not, and unlike the battle between teams and players, these verbal interactions between opposing fan bases take place between the fans before games, during games, and even well after the completion of games. These “contests” between the fans thus provide entertainment value outside of the duration of the game. In fact, these interactions between fans. may provide more entertainment value than an actual game.

Thus, there exists a need for an apparatus, system and method that would provide convenient and improved interaction between fans of media talents, including sports teams, players, entertainers, and the like.

### SUMMARY OF THE INVENTION

The present invention includes a rules-based fan interaction engine, system and method. The engine, system and method include a fan interaction software mechanism for execution by one or more computing processors, including at least one data source associated with at least one relational computing database including a plurality of data indicative of at least two media talents, at least one network communication engine that allows for interactive, real time communications between one or more mobile communication units associated with at least two users and regarding at least two of the at least two media talents, and at least one administrative engine. The at least one administrative engine may be for administrating the interactive, real time communications between the at least two users, and for administering production of ones of the plurality of data to each of the at least two users during the interactive, real time communications, wherein the plurality of data includes a correlation to the two of the at least two media talents.

Thus, the present invention provides an apparatus, system and method that would provide convenient an improved interaction between fans of media talents, including sports teams, players, entertainers, and the like.

### BRIEF DESCRIPTION OF THE FIGURES

Understanding of the present invention will be facilitated by consideration of the following detailed description of the embodiments of the present invention taken in conjunction with the accompanying drawings, in which like numerals refer to like parts and in which:

FIG. 1 is a block diagram illustrating the fan interaction engine of the invention.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in typical rules-based interaction engines, systems and methods. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention.

The present invention may include a clearinghouse that allows for the use of approved, copyrightable, and/or public persona content by non-owners of such content, such as pre-approved photographs, audio, video files, data files, printed text, logos and trademarks, publicity announcements, metatags and metatag streams, and the like.

This information store, or clearinghouse, may include information for use in an advertisement, announcement, data file, or the like, with or without an association with an endorser, affiliate, affiliated product, or the like. This information store may include externally obtained content, internally generated content, or content generally resident as one or more vaults.

This content may include content entered to the vault, content the vault is directed to obtain, and content automatically obtained by the vault. For example, certain personalities may enter content in the vault, including articles, statistics, press releases, photos, videos, advertisements, endorsements, or the like. Other personalities may enter rules governing from where the vault is to obtain content regarding that personality. Yet other personalities may be monitored by one or more rules within the vault, such as wherein mentions of a particular personality, statistics regarding that personality, or the like, are monitored. These mentions or statistics may be positive or negative, for example, and may be automatically or manually classified as to positivity or negativity. Further, this content may be classified, such as into multiple categories, such as “off-field” related mentions, “on-field” statistics, popularity among fans, and the like, and this classification may occur based on the mentions that occur. Such mentions may be obtained, for example, via a web crawl, spider search, or the like, performed at predetermined intervals.

The vault may include one or more rules regarding the use of content in the vault, the allowable interactions with the information in the vault, and the like, and the rules themselves may be classified as information or content as discussed herein. The rules may be implemented, input, or otherwise suggested by an owner of content associated with the rules. As discussed herein, the provided content may be audiovisual content, advertising content, the aforementioned rules, a metatag or metatag stream content, a link, or the like.

The usages allowable for the content, as per the rules selected or entered, may include usage with regard to particular products, causes, announcements, particular geographies, or in association with particular threads, blogs, or key terms, or the like.

More specifically, the present invention includes an interaction engine to take advantage of the entertainment value that is afforded by rivalries and team and player support. The interaction engine of the present invention enhances rivalries by increasing rival communications available between fan bases. In certain embodiments, the interaction engine may provide an enhanced fan-to-fan experience.

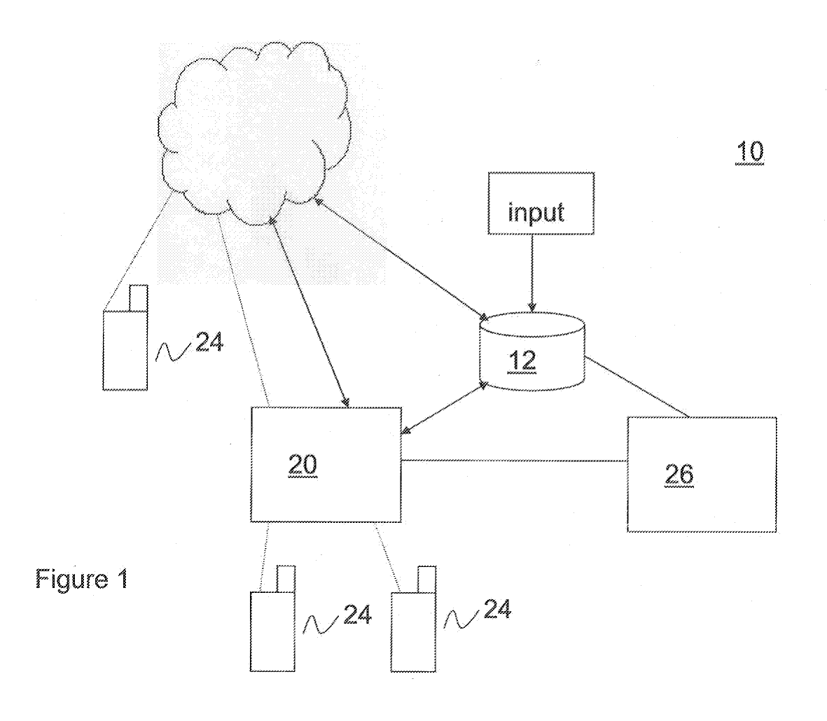

FIG. 1 is a block diagram illustrating the fan interaction engine of the present invention. The fan interaction engine 10 includes at least one data source 12 including data associated with at least two media talents, such as at least two teams or at least two players, at least one network communication engine 20 that allows for interactive, real time communications between one or more mobile communication units 24 associated with two or more fans, and an administrative engine 26 for administrating communications between the two or more fans across the network communication engine.

The data source may be static or dynamic. As such, the data source may be any type of computing memory, including RAM, ROM, a hard disk, a server, flash or the like temporary memory, and/or any type of data connection, including a connection to the Internet, an intranet, an extranet, a telecommunications network, a local storage unit or network, or the like, to provide access to stored data, streamed data, updated data, or the like. Thus, the data source may include the vault discussed herein, including information and data stored in the vault with regard to qualitative and quantitative references to a team or player. Thus, from the vault may be provided the latest data and statistics of interest to a thread, as well as news resources.

Thus, the stored information preferably includes not only performance data, but also data indicative of popularity, rumors such as trade rumors, off field activities, and the like. Thereby, for example, a general, national, and/or local affinity for teams and athletes in correspondent geographic markets, the affinity of famous persons who support a position of a fan, or attendance figures, for example, may be provided by the data source. The vault may additionally provide rules associated with the discussions available and/or allowable regarding a team or players, and/or regarding advertisements that may or may not be provided during fan interactions regarding a team or players. Thus, the data source may encompass the vault to provide, collect and process data on all elements of team or player sports rivalry.

The network communication engine provides a communicative interconnection between two or more communication devices. As such, the network communication engine may include, and/or have accessible thereto, one or more telecommunications networks, such as the Internet, a dedicated network, such as a point-to-point network, a cellular network, a satellite network, or the like. For example, the point-to-point network may be associated with a stadium, wherein localized communications may occur through the network communication engine between rival fans at a game then-occurring at that stadium. Alternatively, rival fans may communicate from the stadium, or from their respective homes, via a connection, or a dedicated connection, between rival fans and through the network communication engine over a cellular network, wireless broadband, such as a WAN or a LAN, or the like.

The network communication engine thus provides a plurality of actual or virtual ports for communication between communication devices via the network communication engine. Such ports may, as will be understood by those skilled in the pertinent arts, be assigned addresses indicating the communicating device, and the communication, or “thread”, in which that device is involved in communicating, and/or threads in which that device is entitled to communicate.

The administrative engine of the present invention may control, monitor, and/or report upon that communications occurring through the network communications engine. The administrative engine may be resident in hardware and/or software, and may include a plurality of rules governing communications between rival fans. Such rules may include age-specific limits on language, team and/or player authorizations to engage in certain types of communications, such as in-stadium communications, or reporting requested by the present invention, teams, players or the like regarding volume, type, or acceptability of usage, for example. The administrative engine may thus manage authentication, communications and communications quality and quantity, authorized users and authorized access to services, by way of non-limiting example. The administrative engine may support and allow for the leveraging of mobile communication devices by administrating the network communication engine.

The interaction engine may be or include one or more software applications that, upon execution, encompass the network communication and administrative engines, and that draw from the data source, to enhance fan interaction and rivalry. This enhancement occurs in a variety of ways. For example, the interaction engine provides more opportunities for fans to interact, including in-venue interaction. Further, new fans are provided for interaction with, in support of a first fan's opinion, and/or against the first fan's opinion. Additionally, access to the data source may provide data “ammunition” to support a fan's perspective on his team and or a contest at hand.

The allowable fan interactions may be head to head conversations, threads, message boards, blogs, postings, instant messagings, or the like, between and/or among opposing fans or fan bases. The interactions may relate to team versus team, athlete versus athlete, or a custom chat, which may be user designed or user generated.

In a typical embodiment, the interaction may be a multi-person chat session in which more than one person is involved in the chat thread. Users may post a message to the thread board, such as via the network communication engine, and such as from on-site at a game. Such a posting user may have accessible information from the data source to help that user formulate postings to the thread. This information may “pop up” for use by the user, such as responsive to user request or responsive to an assessment of subject matter in the thread, or may be available in the thread view, such as alongside the thread, such as in a menu or in banners. Advertisements likewise may be alongside the thread, and may be non-dependent on the thread, may simply be sports or sporting goods related, or may be directly related to an assessment of the subject matters of the thread. As such, the information from the data source and/or any advertisements may change dependent upon references made in the thread.

The administrative engine may oversee and administrate the communication over the network communication engine. The administrative engine may oversee the signing up of users for a log-in account, wherein such a sign-up may include entry of a myriad of useful information, including, for example, the new user's favorite players and teams. Such information may be modifiable over time. Further, for example, the administrative engine may not only allow for the provision of a thread, but may additionally allow for participants to invite rival fans to “step outside” a main thread to have it out one-on-one in a separate, single user thread, wherein the main thread is conveniently carried to the single user thread. In such one-on-one situations, or in main thread situations where possible, other users may “rate” an opponent as to points made, or argument skills, and such ratings may be tracked by the administrative engine.

The administrative engine may oversee permission, and/or issue invitations, for users to engage in a session. Such permissions and/or invitations may require interaction with or through the network communication engine. For example, the administrative engine may issue invitations, alerts or prompts at a given timeframe prior to the start of an actual event, such as 1 week, then 1 day, then 1 hour before the start of the event. These invitations may indicate when fan interactions are allowable, that they are currently allowable, or when the event is to occur, for example. These invitations may prompt for interaction before, after or during the current event, or may allow for referencing of an upcoming, or immediate next, event. Such invitations may be communicated outbound to users via the network communication engine, such as using a preferred communication point correspondent to a user profile in the administration engine.

Likewise, the administrative engine may use, direct, or receive, for example, proximity data of the network communication engine. For example, the network communication engine may allow for an assessment by the administrative engine of a physical location of a user, such as using GPS data available for cellular phones correspondent to ones of the users. Such proximity data from mobile devices may allow for roughly locating nearby like-minded, or opposing-minded, fans, within a seating section, within a stadium, within a town or city, within a certain geographic area, or the like, to thereby allow for an enhanced fan interaction experience. It is preferably, however, that precise fan locations not be exchanged, at least in part to avoid physical confrontations between fans.

The fan interaction engine may provide a back end communication, using the data source, network communication engine, and administrative engine, to allow fans to use the interaction engine from multiple front end platforms, such as the Apple iPhone, FaceBook, MySpace, Twitter, SBNation or the like.

In a specific exemplary embodiment with respect to Apple's iPhone Client (SDK 3), the present invention may leverage event notification functionality, such as by alerting the user to availability of another for a “trash talk,” or by alerting a user to an upcoming “trash talk” session. Likewise, the present invention may leverage proximity/locating functionality in assessing a location of the user, such as at a stadium, to allow for a “trash talk” with fans of the other team playing in the game at that stadium with the user.

A graphical user interface (GUI) application for the iPhone may let users choose players and teams of which they are a fan. Likewise, the GUI may provide access to the aforementioned data source, and the data made available through the data source may be tailored based on the teams and players of which that user is a fan. Further, the GUI may be used to provide graphical and/or textual advertising, which may also be corresponded to the likes and dislikes entered by the user to the GUI, and or to the user's history of use of the iPhone and its applications, for example. For example, advertisements served may include endorsements from the user's favorite player.

Selection by the user of likes and dislikes may additionally cause the availability of certain blogs to which that user will be invited, and/or to which that user may be allowed. For example, the user may be invited to blogs correspondent to a favorite team or teams, to like minded fans, to opposing fans of the user's preferred team or a talent, or to fans of other teams or other talent, for example.

In an additional specific exemplary embodiment, a Facebook application may allow a particular player's fan base to get updated information and content about that player, and the application may be subsidized by advertising, certain of which advertising may include endorsements by that player. For the Facebook application, the user may add an application correspondent to the present invention to the user's Facebook profile, and that application may enable the user to, for example, choose players and/or teams to follow from a list or from search results, choose notification or alert types, such as news, images, third party content, such as odds, a line, or a spread, for example, and/or a participation in a “trash talk.” Likewise, for example, a user may choose a frequency of alerts, notification, updates, information, or the like.

A FaceBook application in accordance with the present invention may prompt the user, for example, to allow access to Facebook profile data of the user, or to allow the application to post to user's “wall.” In the latter instance, for example, the application may post to user's “wall” the subscribed notifications in accordance with the user's selected frequency.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

What is claimed is:

1. A fan interaction software engine for execution by one or more computing processors, comprising:
at least one data source associated with at least one relational computing database, comprising a plurality of data indicative of at least two media talents;
at least one network communication engine that allows for interactive, real time communications:
between one or more mobile communication units associated with at least two users; and
regarding at least two of the at least two media talents; and
at least one administrative engine for administrating the interactive, real time communications between the at least two users, and for administering production of ones of the plurality of data to each of the at least two users during the interactive, real time communications, wherein the plurality of data comprises a correlation to the two of the at least two media talents.

2. The fan interaction software engine of claim 1, wherein said at least one data source comprises a static data source.

3. The fan interaction software engine of claim 1, wherein said at least one data source comprises a dynamic data source.

4. The fan interaction software engine of claim 1, wherein said at least one data source comprises computing memory.

5. The fan interaction software engine of claim 4, wherein the computing memory comprises a server.

6. The fan interaction software engine of claim 1, wherein said at least one data source comprises a data connection.

7. The fan interaction software engine of claim 6, wherein the data connection comprises an Internet connection.

8. The fan interaction software engine of claim 6, wherein the data connection comprises an telecommunications network.

9. The fan interaction software engine of claim 1, wherein said data source comprises a streaming data source.

10. The fan interaction software engine of claim 1, wherein said data source comprises a media asset vault.

11. The fan interaction software engine of claim 1, wherein the plurality of data comprises statistics.

12. The fan interaction software engine of claim 1, wherein the plurality of data comprises news releases.

13. The fan interaction software engine of claim 1, wherein the plurality of data comprises a plurality of rules governing the interactive, real time communications.

14. The fan interaction software engine of claim 1, wherein said administrative engine comprises a plurality of rules governing the interactive, real time communications.

15. The fan interaction software engine of claim 1, wherein said network communications engine comprises a plurality of rules governing the interactive, real time communications.

16. The fan interaction software engine of claim 1, wherein said network communications engine comprises access to global positioning of each of the at least two mobile communication units.

17. The fan interaction software engine of claim 1, wherein said administrative engine comprises a reporting engine for reporting on ones of the interactive, real time communications.

18. The fan interaction software engine of claim 1, wherein the interactive, real time communications comprises communications between geographically co-located ones of the mobile communication units.

19. The fan interaction software engine of claim 1, of claim 1, wherein the real time, interactive communications comprise at least one blog.

20. The fan interaction software engine of claim 1, of claim 1, wherein the correlation comprises a pop-up presented to at least one of the at least two users.
